(19) United States
(12) Patent Application Publication
(10) Pub. No.: US 2008/0311000 A1
(43) Pub. Date: Dec. 18, 2008

(54) Micro-Fluidic System

(75) Inventors: Reinhold Wimberger-Friedl, Veldhoven (NL); Johannus Wilhelmus Weekamp, Beek en Donk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,259

(22) PCT Filed: Aug. 30, 2005
(86) PCT No.: PCT/IB05/52825

§ 371 Date: Feb. 26, 2007

(30) Foreign Application Priority Data
Sep. 3, 2004 (EP) 04104264.9

(51) Int. Cl. B01J 19/00; B29C 39/00; B05D 5/12

(52) U.S. Cl. 422/68.1; 264/279.1; 427/58

(57) ABSTRACT

Micro-fluidic systems comprise components (4), for instance sensors or pump units, which are intended to measure properties of a fluid or exert influence on this fluid, which is conducted in a channel (7). In the present invention, a micro-fluidic system is proposed in which a component (4) is embedded in castjacket material (5), such that a component structure (49) is formed, parallel to which a channel structure (8) is arranged, wherein a channel (7) is incorporated in the channel structure (8). In such a micro-fluidic system, the component can be positioned in relation to the channel in such a manner that a fluid flow with very good flow properties through the channel can be realized.

The invention relates to a micro-fluidic system and a method for creating a micro-fluidic system.

Micro-fluidic systems are increasingly being used in the clinical environment, where a biological/chemical sensor is used as a component in the system to determine the presence or the concentration of specific molecular constituents of fluid body samples from a patient, which are conducted through a channel of the micro-fluidic system. Fluid body samples are especially blood samples, urine samples and cell samples, the cell samples being prepared in a fluid. The specific constituents are, for instance, certain proteins or DNA sequences, which provide clues about infections or other illnesses. The possibility of measuring more or less directly at the patient's bed and the quick access to the measurement results show the major advantage of such systems over the traditional laboratory examinations where the body sample is first sent to a laboratory, where the measurement result is obtained, which is then forwarded to the physician concerned. In order to transfer the body samples to a biological/chemical sensor in a defined manner, cassettes (cartridges) are used, which have a casing in which a channel system is incorporated comprising at least one channel, which channel extends from an inlet for introducing a patient sample over an active measuring surface of a biological/chemical sensor and possibly ends in a cavity into which the body sample is transported after passing through the channel. The biological/chemical sensor is contacted electronically and the measurement result is read out electronically, for instance by linking the micro-fluidic system to a suitable read-out device.

Such micro-fluidic systems are contaminated after a one-time use and are disposed of. This renders it necessary to develop manufacturing methods that are as cost-effective as possible. This also requires the surface of the sensor used to perform specific measurements to be as small as possible, because the smaller the sensor, the more cost-effective it is to manufacture it. When miniaturizing the channel, it is also possible to work with small volumes of body samples, which is desirable especially if many measurements are to be conducted. When miniaturizing the arrangement, special requirements are imposed on the fluid flow in the micro-fluidic system.

Especially, the flow of the fluid should be uniform during transport to the active surface and during transport over the active surface of the sensor; i.e. there should be no no-flow areas where the fluid stagnates in the stream, and a given rate of shear should be maintained.

It is an object of the invention, therefore, to provide a micro-fluidic system and a method of manufacturing a micro-fluidic system that allows, in particular, improved fluid transport.

The object is achieved by a micro-fluidic system with a component structure comprising a component embedded in a cast jacket material, wherein the component structure has a flat assembly side and comprises a channel structure arranged on the assembly side, which channel structure incorporates at least one channel for conducting a fluid, said channel extending parallel to the assembly side at least in the component area, the component being designed for measuring a property of the fluid present in the channel or for influencing said fluid.

A micro-fluidic system with good fluid conduction properties (wherein also gases can be passed through the micro-fluidic system) is required especially by the fact that the component is embedded in a jacket material (for instance, a synthetic resin or another thermoplastic material). The component is integrated in the component structure without appreciable gap between the component and the component structure by embedding it in the cast jacket material. Gaps would for instance be created if the component were to be embedded in a finished component structure manufactured, for example, by injection molding. In the case of embedding by means of cast jacket material, also other components and electrical leads can be simultaneously integrated into the component structure in a single manufacturing step. In such a micro-fluidic system, the component can be positioned in relation to the channel in such a manner that a fluid flow with very good flow properties can be realized through the channel. The flat assembly side of the component structure ensures good connection with the channel structure. The term flat assembly side is not meant to preclude the assembly side from having inlets or outlets from the channel system; also minor depressions in the component area should be ignored. Furthermore, the flat assembly side also means easy realization of the channel, which extends in the component area parallel to the assembly side and thus ensures a good fluid flow over the component area. Slopes in the channel in the component area are thus prevented. This leads to a controlled fluid flow without poor-flow areas, so that a second fluid that is passed through the channel practically completely washes the first fluid from the channel and no disturbing contaminants remain behind.

In an embodiment of the micro-fluidic system, wherein the component structure forms a boundary wall of the channel, it is easy to ensure that the resultant channel height is substantially constant in the micro-fluidic system. Especially since the component structure has a substantially flat assembly side that connects to the also flat channel structure, a channel of substantially constant height is obtained. As the component is embedded in cast jacket material, the assembly side of the component structure can essentially serve as a substantially planar termination of an active surface of the component. Direct contact of the active surface of the component as well as a substantially constant channel height is thus ensured.

If electrical leads to the component are needed, it is advantageous to connect them on the same side on which the active surface of the component is formed also, because electrical plated-through holes through the component to the other—inactive—side can then be dispensed with. The electrical leads may additionally form a part of the assembly side.

In another embodiment, a substrate layer is arranged between the component structure and the channel structure. In the manufacture of the micro-fluidic system, the substrate can be used as a stabilizing support when the component is positioned and subsequently jacket material is cast around it.

In yet another embodiment, the component is intended for wireless exchange of data and/or energy with an external unit such as a data processing and/or control and/or energy supply unit. By virtue thereof, even necessary electrical leads to the component become redundant and the active surface of the component can be accurately terminated with the assembly side of the component structure.

The invention relates also to a method of manufacturing a micro-fluidic system as claimed in claim 1, which comprises the following steps:
Manufacturing a component structure by means of the following sub-steps:
   Arranging at least one component on a flat substrate,
   Casting a jacket material around the component,
   Partially or completely removing the substrate, such that the component structure gets a flat assembly side, and
Connecting a channel structure with the component structure, such that a channel, extending in the component area essentially parallel to the assembly side, is created for conducting a fluid.

A substrate is used in this manufacturing process, which is sacrificed partly or wholly in the course of the process. A stable substrate can thus be used on which the component is positioned before jacket material is cast around it. The substrate provides the necessary stability till the jacket material has cured and can then be removed, because the cured jacket material with the embedded component forms a finished component structure having its own stability. The flat design of the substrate results in a flat assembly side of the component structure. Furthermore, a flat substrate can also be readily removed again, for example by mechanical stripping.

In another design, the manufacturing process has the following additional steps: creating at least one electrical lead on the substrate and connecting at least one contact point of the component with said electrical lead. Especially in the case of components which need to be in contact with electrical leads for energy supply and data exchange, the leads can be formed first on the substrate (for example by printing on the flat substrate). After stripping off the substrate, the electrical leads then form a part of the flat assembly side.

A further development of the manufacturing process comprises this sub-step:

Providing chemical and/or biochemical areas on the active surface of the component.

Another further development of the manufacturing process comprises the sub-step of depositing filler material into intermediate spaces between the component and the substrate. This causes the component to be sealed with respect to the substrate and thus, in the finished micro-fluidic system, the component is embedded in such a manner that formation of chambers for sedimenting fluids does not take place. The sub-step of depositing filler material can be part of the jacketing process: The same material can be used. It is also possible to use even less viscous material, which would fill up the interspaces between component and substrate particularly well. This can cause a complete filling up of the interspace between the active surface of the component and the substrate, or the interspace is filled up only so much that the active surface remains free. The latter is necessary if the active surface of the component has to come into direct contact with the fluid in the channel.

These and other aspects of the invention are apparent from and will be elucidated, by way of non-limitative example, with reference to the embodiment(s) described hereinafter.

### IN THE DRAWINGS

FIGS. 1a, b are, respectively, a side view and a plan view of the first sub-step of a method of manufacturing a micro-fluidic system in accordance with the invention,

FIGS. 2a, b are, respectively, a side view and a plan view of the second sub-step of the manufacturing process, wherein electrical leads are generated on a substrate,

FIGS. 3a, b are, respectively, a side view and a plan view of the third sub-step of the manufacturing process, wherein a component is placed in this case,

FIGS. 4a, b are, respectively, a side view and a plan view of the fourth sub-step of the manufacturing process, wherein a component is jacketed in this case,

FIGS. 5a, b are, respectively, a side view and a plan view of the fifth sub-step of the manufacturing process, wherein a substrate is removed in this case,

FIGS. 6a, b are, respectively, a side view and a plan view of the sixth sub-step of the manufacturing process, wherein, in this case, a channel structure is provided, so that a micro-fluidic system is created,

FIGS. 7a, b show two sections from micro-fluidic systems according to known embodiments, which are prone to the development of no-flow or poor-flow areas,

FIGS. 8a, b show two micro-fluidic systems according to alternatives of the manufacturing process according to the invention,

FIG. 9: diagrammatically shows a micro-fluidic system, wherein a plurality of components are integrated and a plurality of channels are formed,

FIG. 10: is a cross-sectional view of the micro-fluidic system of FIG. 9 along the line D-D′,

FIG. 11: is a cross-sectional view of the micro-fluidic system of FIG. 9 along the line C-C′, and

FIG. 12: is a cross-sectional view of the micro-fluidic system of FIG. 9 along the line C-C′, according to an alternative embodiment.

Hereinbelow, first a description is given of exemplary sub-steps in the manufacture of a micro-fluidic system in accordance with the invention, with reference to FIGS. 1a, b-FIGS. 6a, b. FIGS. 1a, b to 5a, b show the manufacture of a component structure and FIGS. 6a, b show the connection of the component structure with a channel structure for producing a micro-fluidic system.

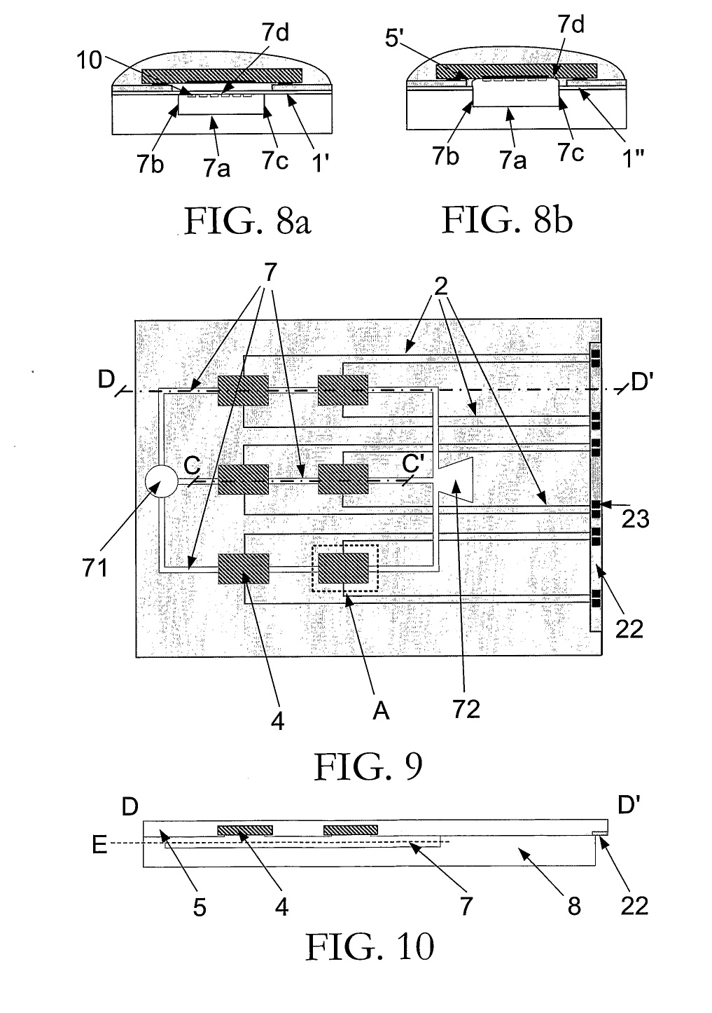

FIGS. 1a and 1b show a substrate 1 that is made of e.g. aluminum (Al) or an aluminum alloy and on which a layer of electrically conducting material 21, such as copper (Cu), is deposited. Other substrate materials and electrically conducting materials, known to the person skilled in the art, are assumed to be included in the description. A dashed line denotes a recess 12, which may be provided in the substrate and in the layer 21 of electrically conducting material, and the significance of which is described in the context of FIG. 8b. FIG. 1a is a side view and FIG. 1b is a plan view, which is achieved by rotating the side view by 90 degrees about a horizontal axis in the plane of the image in the direction of the lower image edge, so that the plan view shows the layer of electrically conducting material 21. In the plan view in FIG. 1b the possible recess 12 is also denoted by a dashed line. Furthermore, a dash-dot line L in FIG. 1 indicates that the substrate may also have two layers. The thicker layer, lying at the bottom in the image plane, may be of aluminum and the thinner layer, lying at the top in the image plane, may be of plastic. The meaning of a two-layered (or multi-layered) substrate is explained further down in this document with reference to FIG. 8a. In FIGS. 1a, b to 6a, b and 8a, b, the size of the substrate shown should not be construed in a limiting sense. The arrangements shown may relate to the manufacturing steps of a section of a larger micro-fluidic system as shown in FIG. 9, for example section A, which is depicted in broken lines in FIG. 9.

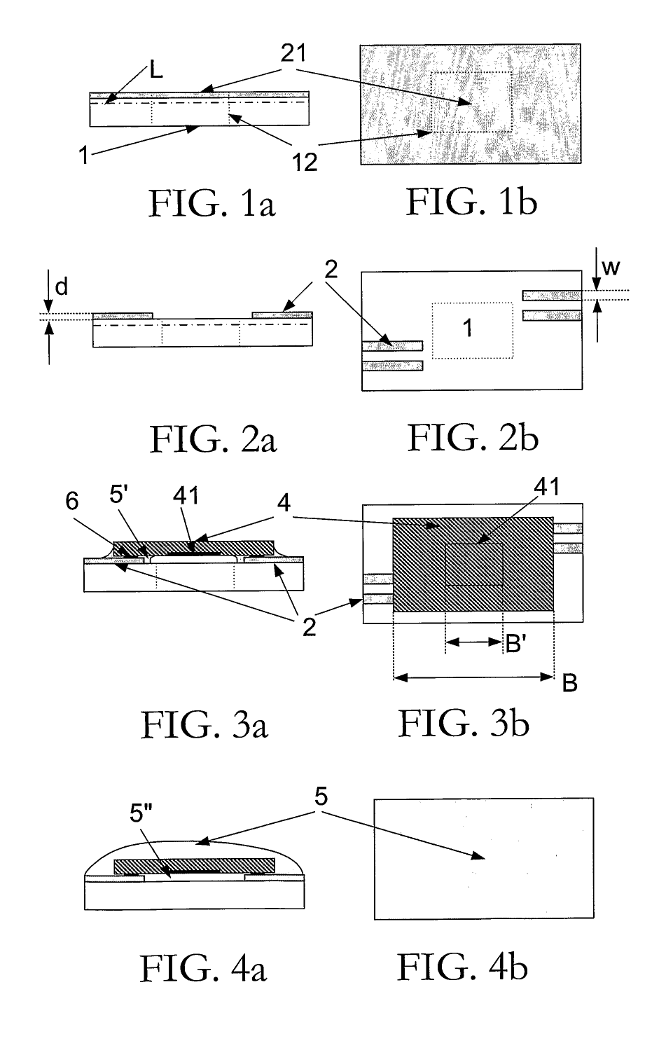

FIG. 2a and FIG. 2b show, respectively, a side view and a plan view, as in FIGS. 1a and 1b, after the electrically conducting layer has been structured by lithographic processing. In this sub-step of the manufacturing process, electrically conducting leads 2 are made from the electrically conducting material of the layer 21. The leads 2 in this embodiment have a thickness d of 10 μm and a width w of approximately 50 μm. The exact values for d and w depend on the type of manufacture and the requirements. Besides the lithographic structuring of a continuous layer of electrically conducting material 21 described here, the electrically conducting leads 2 can also be generated by printing on the substrate 1 or by other known techniques. Four leads are shown in the example shown here. This is not to be construed in a limiting sense. Depending on the requirements, a component (see FIGS. 3a, b), to which the leads 2 are to lead, can be contacted by one, four, ten, 32, etc. leads 2. The number of leads 2 depends on the type of component. As will be described further down in this document, there are also embodiments for which leads 2 are not needed. The manufacturing steps with the electrically conducting material are then eliminated.

FIGS. 3a and 3b show the next sub-step of the manufacturing process in, respectively, a side view and a plan view, wherein a component 4, such as in particular a sensor, is placed such that one or several contact points 6 of the component 4 are brought into contact with one or more electrically conducting leads 2. The component 4 has an active surface 41, which is configured on the surface of the component 4 facing the substrate. The active surface 41 can be roughly of the size of the possible recess 9. In a typical embodiment, the component 4 is a silicon-based sensor and has a surface area of 1.4×1.4 mm² and a thickness of 0.7 mm; the active surface measures about 0.8×0.8 mm². In the plan view, the active surface 41 configured on the opposite side is indicated by a rectangle drawn in a full line. Instead of a rectangle, the active surface 41 can, of course, also be configured in another shape. One of the remarkable features of the active surface 41 may be that the component 4 is configured in this area in such a manner that measurements can be carried out there by means of, for example, a photo diode or a magnetic field sensor arranged there. The active surface should be understood to mean the upper surface of the component, making it possible for the actual sensors to be formed also at a certain depth in the sensor, for instance in several superposed layers, and the sensor may be covered by a passivation layer. The component 4 can be positioned with its contact point(s) 6 on the supply line(s) 2 by Flip-Chip-Bonding. The contact points 6 are linked with the leads 2 in a usual manner, for example by the application of ultrasound. Furthermore, the component 4 can be glued to the leads 2 and the substrate 1 in the areas which are not in direct contact with the leads 2 and/or the substrate 1, by an underfilling procedure in which adhesives (for example epoxides with low viscosity) are used as underfilling material 5′. This underfilling procedure ensures sealing of the component 4, i.e. the fluid coming into contact with the active surface 41 cannot, in the constellation shown here, laterally flow out from between component 4 and substrate 1 and leads 2. Furthermore, this increases the mechanical stability. In the embodiment shown, the component 4 is, for example, a sensor based on silicon, which is to be used for measuring molecular constituents of a fluid.

FIGS. 4a and 4b show a next sub-step of the manufacture of the micro-fluidic system in, respectively, a side view and a plan view. Here the component 4 is enveloped in a jacket material 5. In addition, it is shown that either in the sub-step of underfilling, the entire interspace between component 4 and substrate 1 was filled with underfilling material 5″ or that in the sub-step of enveloping with jacket material 5, the interspaces between component 4 and substrate 1 are filled up by the jacket material 5. A low viscosity jacket material 5 can be used for this purpose. The jacket materials used are especially plastics, such as reactive molding compounds (epoxides) or thermoplastics (for example polycarbonate or COP—“cyclic olefine polymers”). Also other easy flowing plastics compatible with biological applications can be used. For jacketing, the substrate 1 can be placed in a cavity and the entire substrate side on which the leads 2 are formed and on which the component 4 (or several components 4) are placed, can be covered homogeneously by the jacket material 5 (also see FIGS. 9 and 10 in this context). Complete underfilling of the component 4 is possible then, if the component 4 can execute its function through a layer of underfilling material; if so, the use of a transparent material leading to the generation of fluorescent light makes it possible to measure through the layer by means of a photodiode. The presence of magnetic particles can also be measured through a layer of underfilling material by a magnetoresistive sensor (in this context, reference is made to European patent Application EP 04102257).

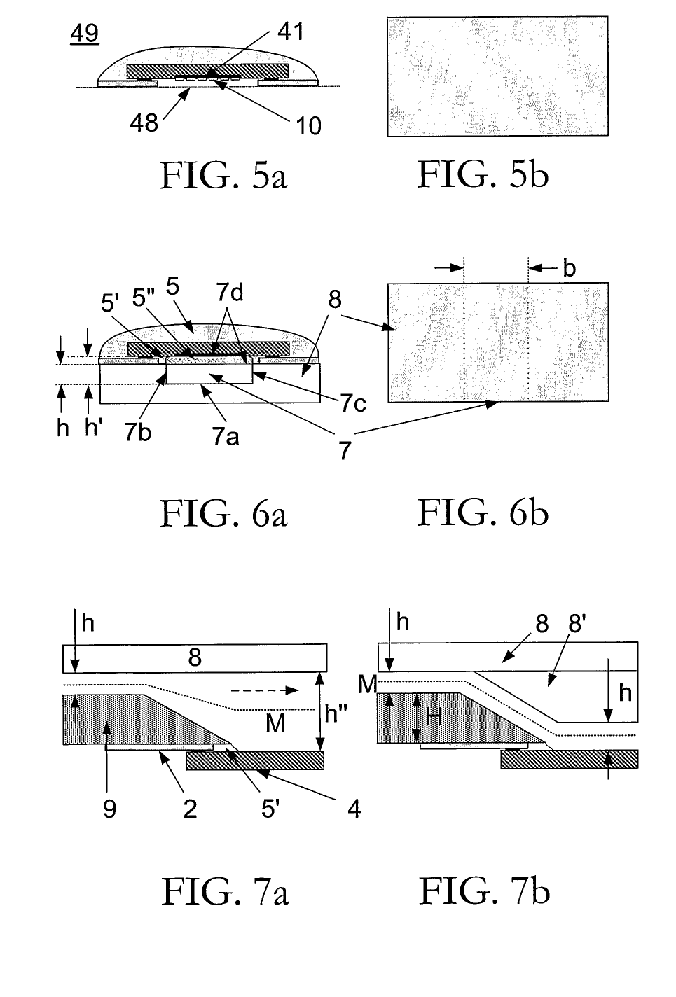

FIGS. 5a and 5b show a next sub-step of the described manufacturing process in, respectively, a side view and a plan view. The substrate 1 is completely removed here. This can be achieved by chemical dissolution of the substrate 1 or by mechanically pulling off the substrate 1. The pulling off is easier if the electrical leads are anchored well in the jacket material 5. The component 4 is integrated in a component structure 49 by the jacket material 5. After the jacket material 5 has cured, the component structure 49 obtains mechanical stability which persists even after the complete removal of the substrate 1 shown here. As the substrate itself is flat, the resultant assembly side 48 of the component structure is also flat. The term “flat assembly side 48” should also be taken to mean that the component area includes depressions in the component structure as shown in FIG. 5a. If the interspace between component 4 and substrate 1 has been previously filled up completely with jacket material or underfilling material, then a flat assembly side 48 without depressions in the component area is obtained.

If the component 4 is a sensor, then biologically active areas 10 can be formed on the active surface 41 in a next sub-step. Biologically active areas 10 are distinguished by the fact that they have specific coupling points (so-called receptor molecules), to which the components (targets) to be identified of the body sample (proteins, RNS or DNA components, etc.) bind. The components to be identified are provided with labels beforehand, which have a property that is measurable by the sensor (such as fluorescent labels, whose light emissions can be measured by means of one or more photo diodes, or magnetic particles whose influence on the magnetic field can be measured by means of a GMR-Sensor—“Giant Magnetic Resonance-Sensor”). The receptor molecules catch the components to be identified and ensure an enhancement of the measurable property of the label at the biologically active areas 10 and thus an increase in a measured signal from these biologically active areas 10. The dimensions of the biologically active areas 10 shown here are not to be understood as being drawn to scale. As these are coupling points of molecular size, the height dimension of these areas do not exceed, for example, a few nanometers. The measured signals of the sensor are read out through one or more leads 2. Other leads 2 are used for power supply to the sensor.

Instead of a sensor, another element can be used here as the component 4, such as a piezo element, which can be used to control the fluid transport. Different components 4 can be integrated in one micro-fluidic system. The components 4 are then used either to measure a property of the fluid (e.g. whether and in what concentration a certain molecular component occurs in the fluid, the temperature of the fluid, the fluid velocity etc.) or to influence the fluid, for instance, by mechanically controlling the flow of the fluid or by exerting thermal influence (heating or cooling) etc.

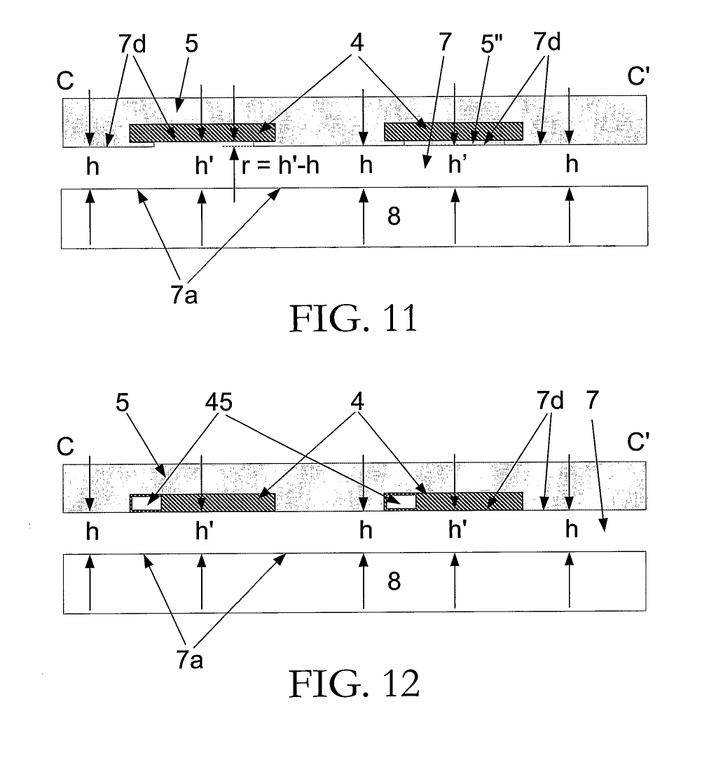

As the last step of the manufacturing process, FIGS. 6a and 6b show in, respectively a side view and a plan view, how a channel structure 8, in which at least one channel 7 with channel walls 7a, 7b, 7c is integrated, is connected with the component structure 49 (see FIG. 5a). The channel structure 8 shown here is a plastic structure, which can be manufactured by a plastic injection molding process, and the connection is effected by adhering. In another embodiment, the channels 7 of the channel system structure 8 defined by the channel walls 7a, 7b, 7c are formed in a plastic block by mechanical processing, such as milling. Channels can, however, also be produced by hot-stamping a plastic block on a metal negative. After connecting the channel structure 8 to the component structure 49, the channel 7 is terminated by a channel wall 7d (the biologically active areas 10 have not been drawn here, for the sake of simplicity). The channel wall 7d is defined by the component structure. After removing the substrate 1, the component structure 49 has a flat assembly side, with the exception, if necessary, of the points where the components 4 are integrated. FIG. 6a indicates that there are several possibilities. Either, the underfilling material 5′ has been used only for sealing the component 4 with respect to the substrate and the active area of the component 4 can come into direct contact with a fluid in the channels 7, or the underfilling material 5″ (shown in light-grey shading) has underfilled the entire component 4, resulting in a completely flat assembly side. Biologically active areas can then be formed on the underfilling material. As can be seen in FIG. 6a, the channel height h′ (distance between the lower broken line in the Figure and the dot and dash line at the top) between channel wall 7a and the active surface, which forms the channel wall 7d in this area, is not very different, if the active area has remained free, from the channel height h (distance between the lower broken line in the Figure and the upper broken line) of the shown channel 7 in the channel structure 8 itself and which is also reached in areas outside the integrated component 4, where the channel wall 7d is defined by the cured jacket material 5 (also see FIG. 11 for further explanation). If the underfilling material 5″ has underfilled the entire component, then the channel wall 7d is formed by the underfilling material and the channel height also remains constant in the component area. The channel dimensions are, in an exemplary embodiment, h=100 μm for the height and b=1 mm for the width. Here, however, also a plurality of channels with a width of b=100 μm can be used next to each other, instead of a single channel with a width of b=1 mm, which is advantageous for the fluid flow. Furthermore, other channel dimensions are conceivable, especially channels with even smaller dimensions leading to further miniaturization, for instance channel dimensions up to 10 μm. The channel structure 8 is distinguished by channels which are open on one side. Closed channels 7 with channel walls 7a, 7b, 7c, 7d are formed by connecting the channel structure 8 with the component structure 49.

Embodiments of an arrangement comprising integrated component 4 and fluid channel 7, which do not meet the specification of transporting the fluid with a uniform flow and a constant rate of shear, are shown in the sectional views of FIGS. 7a and 7b. These side views show sections taken along the direction of flow. The fluid flow is indicated by a broken line arrow in FIG. 7a. The electrical leads 2 are placed on a carrier 9 and the component 4 has been connected to the leads 2 by Flip-Chip bonding via contact points. The component 4 is sealed with respect to the carrier 9 by means of an underfilling material 5′. The channel structure 8 has been glued onto the carrier 9 in such a manner that channels with a channel height h (here about 100 μm) form outside the component 4. By using the carrier 9, however, the channel deepens at the point where the component 4 is arranged and this results in a channel height h″, which is obtained from the height h of the channel itself, the thickness H of the carrier 9 and the thicknesses of the electrical lead 2 and a contact point. At the end of the component 4, the channel is narrowed again to a channel height h (imagine the section of FIG. 7a to be mirrored vertically in the image plane so as to continue on the right hand side in FIG. 7a). Typical thicknesses H for the carrier 9 are H=100-300 μm, which means that the channel height h″ over the active surface of the component 4 is at least double the channel height h in the areas outside the component 4. As the carrier 9 is to carry out the function of providing mechanical stability, smaller thicknesses than H=100 cannot be realized in a useful manner. Especially in the case of sloping channel walls and such appreciable depressions, there could be stationary areas in which the fluid is not transported. This is disadvantageous for measurement operations in which a second fluid is supposed to clean the area around the component 4 from ingredients of the first fluid. The stationary areas are not cleaned then, which affects the measurement operations.

FIGS. 7a and 7b are cross-sectional views in the direction of flow along the channel of a micro-fluidic system according to the prior art (such a micro-fluidic system has been described in patent application 03103820.1 submitted to the European Patent Office). Here, for elucidation, only the area on one side of a component 4 is shown, where the channel 7 meets the component 4.

The broken line M in FIG. 7a shows the path of the geometrical center axis of the channel. For an assumed very small height H=100 μm of the carrier 9 and a channel height h=100 μm, the central axis sinks by at least 50 μm in the direction of the component 4 (the additional height difference as a result of supply line 2 and the associated contact point and possibly a further passivation layer is ignored here). Furthermore, for an assumed channel width b=1 mm (see FIG. 6b), the channel's cross sectional area h×b increases from h×b=100 μm×1000 μm to h″×b=200 μm×1000 μm. Since the central axis of the channel does not extend mainly in an extension plane of the channel, but distinctly deviates from an extension plane in the area of the component, and additionally the channel cross section increases by a factor of two, the development of areas of stagnating fluid flow is promoted.

FIG. 7b shows a modified embodiment with respect to FIG. 7a. A more complex channel structure 8 is used here, which is designed such that it has a bulge 8′ at the location where the channel widens. The bulge 8′ is dimensioned such that the channel height h is retained; the depression is thus compensated and accordingly the channel cross section also remains more or less constant. This, however, has several disadvantages: Firstly, the channel does not flow in an extension plane, but slopes towards the component 4 and away from the component 4, which has an adverse effect on the flow. The broken line again shows here the geometrical central axis of the channel. For an assumed height H=100 μm of the carrier, the central axis thus sinks by 100 μm in the direction of the component 4. This corresponds to the channel height h=100 μm assumed here. Secondly, this makes the manufacture of the channel structure 8 with bulge 8′ more complex and therefore costlier, especially because this imposes higher requirements on the precision of the entire channel structure 8, 8′. Thirdly, the assembly and alignment of the channel structure 8, 8′ and of the carrier 9 becomes more difficult and must meet high requirements. Especially for the desired channel heights of approximately h=100 μm or less, the said disadvantages are important.

FIGS. 8a and 8b shows two alternative embodiments of a micro-fluidic system in accordance with the invention.

A substrate layer 1′ has remained in the arrangement in FIG. 8a. The original substrate 1 (see FIG. 1a) can be reduced here to a smaller thickness, for example, by mechanical or chemical processing. It is also possible that the substrate 1 consists of two layers, as indicated in FIG. 1a by the line L, and one layer is removed after jacketing the component 4, e.g. by mechanical stripping or chemical dissolution. If stripping is applied to a two-layer substrate, one layer of the substrate 1′ remains on the component structure 49. The two substrate layers can be easily removed from each other. In case there are two layers of appropriately selected different materials, it is possible to remove one layer chemically (=dissolve) without the other layer being adversely affected. This is the case, for example, when use is made of a thick layer of aluminum, which is used for creating stability, and a thin layer of plastic, which remains as a substrate layer 1′, after the aluminum is dissolved. In FIG. 1a, biologically active areas 10 are arranged on the substrate layer 1′. If the component 4 is a sensor, the sensor is capable of measuring, through the substrate 1′, the concentration of the labeled targets coupled to the biologically active areas 10, while in the case of for example magnetic labels, measuring takes place through a substrate 1′ of aluminum or plastic. Also here, it is advantageous that the active surface of the component 4 is arranged very close to the remaining substrate layer 1′ by the described manufacturing process. This is so, because a measurement deteriorates as the distance increases. This can be attributed to the fact that the relevant solid angle of the active surface decreases quadratically with distance, which leads, for example in the case of fluorescent labels, to an ever weaker signal as the distance increases and thus to worse measurement results (affected by background signals and noise).

In FIG. 8b, the original substrate 1 or a top substrate layer had been provided with a recess 12 (see FIGS. 1a, b). As described with reference to FIG. 8a, a substrate 1 with a continuous recess 12 can be reduced to a smaller thickness mechanically or chemically, or the substrate 1 consisted of a—in the image plane—top layer 1″ in which a recess 12 (see FIG. 1a) was provided and of a lower layer without an opening, wherein the lower layer was, for example, mechanically stripped off so that only the substrate layer 1″ with an opening remained. In this embodiment, the biologically active areas are again provided on the active surface, and the active surface of the component 4, as shown in FIG. 6a, is in direct contact with a fluid that is transported through the channel.

FIG. 9 shows a micro-fluidic system, which has been manufactured by the manufacturing process described herein. The embodiment shown has six integrated components 4, each provided with two electrical leads 2 for the purpose of elucidation; this is to be understood schematically, however, and the number of electrical leads should not be restricted hereby. In another embodiment, an integrated component 4 has some 32 electrical leads. In yet another embodiment, an integrated component 4 has no leads 2 (in this context, reference is made to the description in connection with FIG. 12). The number of leads 2 depends on the type of component 4, possibly on the number of measured values, which are to be read out from an integrated component 4, etc. Such a micro-fluidic system can also comprise a single component or 100 components, instead of six integrated components 4, as shown here. The electrical leads 2 end here in contacts 23 to a connecting element 22, which can perhaps be a standardized coupling to a reading device for such micro-fluidic systems of the type shown. Besides components 4 and leads 2, other electronic components can pertain to the micro-fluidic system, such as signal processors, which process the measured values of the components 4 already in the arrangement or which activate a component configured as a piezo element and thus control the temporal fluid flow. Instead of signal processors, or in addition to them, also one or more memory chips can be integrated for intermediate storage of the measured values. Such electronic components can also be connected with the electrical leads 2 through Flip-Chip bonds, before the arrangement is covered with jacket material.

Furthermore, a simple channel system is shown in FIG. 9, which consists of three channels 7 running horizontally in the image plane and other supply channel sections, wherein two components 4 lie along each of the channels 7 of the channel system. Furthermore, the channel system has one inlet 71, where a fluid (e.g. a blood sample) can be filled in the channel system through an injection, and a cavity 72 for collecting the fluid after passing through the channel system. Instead of the simple channel system shown, the arrangement can also have much more complex channel systems, which have other channels of different thickness and length, valves, pumps etc. Especially, such an arrangement can also have one or more other cavities in which a flushing fluid may be stored, which is transported through the channels after the passage of the first fluid (blood sample), to clear the components 4 of incidental deposits of labeled components which did not bind to a marker. The various elements of the arrangement shown in FIG. 9 are not to be taken as drawn to scale.

FIG. 10 shows a cross-sectional view of the arrangement as shown in FIG. 9, along the line D-D′. Two integrated components 4 are arranged over a channel 7 and enveloped by jacket material 5. It is shown here that the jacket material 5 (see FIGS. 4a, b) is deposited in a homogenous thickness throughout the surface of the arrangement, such that a mechanically stable unit is obtained, before, according to FIGS. 6a, b, the substrate 1 is removed wholly or partially (see FIG. 8a, b). The channel 7 is formed in the channel structure 8, which has been connected to the component structure 49 by adhering. No leads are shown in FIG. 10, because the line D-D′ does not intersect any electrical lead 2. The connecting element 22 is not covered entirely by the channel structure, so that the contacts 23 can be contacted by a reading device. The broken line E shows the extension plane of the channels 7.

FIG. 11 shows a section through the arrangement as shown in FIG. 9, along the line D-D′. Also here, no electrical leads are shown, because, like in FIG. 10, the line C-C′does not intersect any lead 2. Two integrated components 4 are shown in the sectional view, which are enveloped by jacket material 5. A component 4 is shown to the left that was only sealed with the underfilling material, so that the active area has remained free, and an embodiment is shown to the right, wherein the component 4 was underfilled completely by the underfilling material 5″, before the substrate was removed. Completely underfilled components and components only sealed by underfilling material can occur in a micro-fluidic system simultaneously. In the image plane below the components 4, there runs a channel 7 of the channel system that is incorporated into the channel structure 8. The channel height between channel wall 7a and channel wall 7d varies only minimally along the course of the channel 7 for the non-underfilled component on the left hand side. The channel height in the channel structure 8 itself is h, for example h=100 μm. As a result of the described manufacturing process, the active surfaces of the component 4 are recessed only a little. In the case of a non-underfilled component 4, the channel height between channel wall (in image plane below) and active sensor surface is h′=h+r. For a height of the electrical leads of about 10 μm, and a contact point thickness of about another 10 μm, a height variation is obtained of about r=h′−h=20 μm and thus a channel height of h′=120 μm. The geometric central axis of the channel 7 rises in these areas by only 10 μm in the direction of the components. The central axis of the channel 7 thus lies predominantly in the extension plane of the channel 7. For an assumed channel width of b=500 μm, the cross-section of the channel 7 varies only between h×b=100 μm×500 μm and h′×b=120 μm×500 μm and thus remains substantially constant. Through the described manufacturing process, in which, in succession, the electrical leads are formed on the substrate, the components 4 are connected to the leads 2, the components 4 are enveloped by jacket material 5 and the substrate 1 is removed, an almost flat component structure 49 is created, in which only the not completely underfilled active sensor surfaces are recessed by about r=20 μm. This value is not problematic even for small channel heights of 100 μm. The flow of the fluid (body sample) remains practically uninfluenced by this channel height variation; a constant rate of shear is maintained and stationary areas in the flow do not occur. The channel height h′ for a completely underfilled component 4 is given by h′=h. In such a case, the channel height remains constant also in the component area without any depressions. Furthermore, it is advantageous that the central axis of the channels 7 runs substantially in one plane (extension plane E—see FIG. 10); the channel structure 8 can thus be defined, for example, by means of a plastic injection molding method or hot-stamping using a simple metal negative, because no bulges 8′ (see FIG. 7b) are needed. This metal negative, that is used in the plastic injection molding appliance, is manufactured by lithographic processes. As no slopes and channels need be configured on various planes as shown in FIG. 7b, the manufacture of such a metal negative is both easy and cost-effective.

For another embodiment of the arrangement of FIG. 9, FIG. 12 shows a section along the line C-C′. In the alternative embodiment shown, the components 4 in the manufacturing step shown in FIGS. 3a, b are placed directly on the substrate 1 and are then enveloped with jacket material 5. In this alternative embodiment, the components 4 have a transmitting/receiving unit 45, by means of which measured data from the components 4 and control data from external units can be exchanged. Also energy can thus be supplied wirelessly in known manner. In such a wireless embodiment, the active surface of the components 4 lies directly on the substrate 1 (see FIG. 3a, b) because leads and contact points can be dispensed with. The active surface is arranged in one plane with the cured jacket material after removal of the substrate, so that a constant channel height h=h′ is obtained between the channel wall 7a and the channel wall 7d both on the active surface and outside the active surface of the components 4. As no leads are needed in this embodiment, the substrate can have markings for exact positioning of the components, so that the resulting component structure 49 and the channel structure 8 fit each other precisely. Components with leads and components without leads can also be combined in a micro-fluidic system.

1. Micro-fluidic system with a component structure (49) comprising a component (4) embedded in cast jacket material (5), wherein the component structure (49) has a flat assembly side (48) and comprises a channel structure (8) arranged on the assembly side (48), which channel structure incorporates at least one channel (7) for conducting a fluid, said channel extending parallel to the assembly side (48) at least in the component area, the component (4) being designed for measuring a property of the fluid present in the channel (7) or for influencing said fluid.

2. Micro-fluidic system as claimed in claim 1, characterized in that the component structure (49) forms a boundary wall (7d) of the channel (7), such that the channel height (h) in the component area is substantially constant.

3. Micro-fluidic system as claimed in claim 2, characterized in that the channel height (h) in the component area varies at the most by one-third of the channel height (h), wherein especially for a channel height (h) of about 100 μm the height variation (r) of the channel height is not more than about 30 μm.

4. Micro-fluidic system as claimed in claim 1, characterized in that electrical leads (2) to the component form a part of the assembly side (48).

5. Micro-fluidic system as claimed in claim 1, characterized in that a substrate layer (1′) is arranged between the component structure (49) and the channel structure (8).

6. Micro-fluidic system as claimed in claim 1, characterized in that the component (4) is equipped for wireless transmission and/or reception of data and/or energy.

7. Method of manufacturing a micro-fluidic system as claimed in claim 1, comprising the following steps:
Manufacturing a component structure (49) by means of sub-steps:
Arranging at least one component (4) on a flat substrate (1),
Casting a jacket material (5) around component (4)
Partially or completely removing the substrate (1), such that the component structure (49) gets a flat assembly side (48), and
Connecting a channel structure (8) with the component structure (49), such that a channel (7), extending in the component area essentially parallel to the assembly side (48), is created for conducting a fluid.

8. Method as claimed in claim 7, characterized in that it has the following further sub-steps for manufacturing the component structure (49):
Creating at least one electrical lead (2) on the substrate (1) and
connecting at least one contact point (6) of the component (4) with the electrical lead (2).

9. Method as claimed in claim 7, characterized in that it comprises the following additional step:
Providing chemical and/or biochemical areas (10) on an active surface (41) of the component (4).

10. Method as claimed in claim 7, characterized in that it comprises the following additional sub-step for manufacturing the component structure (49):
Depositing filler material (5′) in interspaces between the component (4) and the substrate (1).
